(19) United States
(12) Patent Application Publication
(10) Pub. No.: US 2008/0088045 A1
(43) Pub. Date: Apr. 17, 2008

(54) Method for the Modification of a Microstructure of an Object

(76) Inventor: Achim Hansen, Zug (CH)

Correspondence Address: Charles R Hoffmann;Hoffmann Baron LLP, 6900 Jericho Turnpike, Syosset, NY, 11791, US

(21) Appl. No.: 11/631,567

(22) PCT Filed: Jul. 7, 2005
(86) PCT No.: PCT/EP05/07358

§ 371 Date: Mar. 21, 2007

(30) Foreign Application Priority Data
Jul. 10, 2004 (DE) 102004033424.2

(51) Int. Cl. B29D 11/00

(52) U.S. Cl. 264/2.6; 264/1.1; 264/2.7

(57) ABSTRACT

There is described a method of surface modification and/or volume modification of a microstructure at and/or in the material of an object, wherein firstly the microstructure is produced at and/or in the material of the object and then volume contraction of the material for reduction of the relative structure dimensions of the microstructure of the object is effected. Very fine microstructures can be produced comparatively simply and inexpensively by means of the method according to the invention.

The invention concerns a method of surface modification and/or volume modification of a microstructure on a material and/or in the material of an object.

Objects or materials with a microstructured surface are used for example as optical elements and components, as materials with definedly modified surface properties, or as functional components.

Modified microstructured surfaces are employed for instance as optical structures for example in the form of holograms, as light-scattering structures, as structures which are part of an optical component such as for example a lens array, prisms, or retroreflecting structures. Structures with defined surface properties are for example structures which specifically and targetedly influence the wettability, electrical properties or mechanical properties. Wettability is known for example as the ‘lotus blossom effect’; the electrical or electronic properties are for example structures for LEDs, ‘Lab on Chip’ and so forth. The mechanical properties are for example the frictional characteristics, that is to say influencing of the static and/or sliding friction coefficient of the article provided with the corresponding microstructure.

Volume-modified materials or objects have for example microstructures in the form of holes, passages and/or openings in various different forms. Volume-modified materials of that kind are used for example as filters, membranes, electronic components and so forth.

Combinations of surface modification and volume modification are possible by direct methods or by shaping methods. The direct methods involve for example so-called direct structuring by means of a laser, lithographic methods such as an X-ray lithography method or in particular an electron beam lithography method, masking methods, etching methods and mechanical methods such as scratching for example by means of diamonds. Embossing by means of dies is also possible. The shaping methods involve shaping for example by means of mechanical processes or by means of hardenable materials which for example can be UV casting resins or the like.

The production of structured surfaces by direct methods or by shaping methods of the above-indicated kind is often limited by virtue of technical and/or commercial influences. Thus a generally known factor for limiting the holographic production of microstructures is the light wavelength used. To produce very fine structures, short-wave lasers and complex and often cost-intensive test structures and materials are involved. Very fine structures can be implemented by means of electron beam installations. With the electron lithography procedure which is used in that respect, structures of 0.1 μm in depth or less can be produced with electron beams of usually 5 to 50 keV on an electron-sensitive lacquer layer—which for example was applied to a raw chip. In that respect the so-called proximity effect has a resolution-limiting action, due to scatter of the electrons at the semiconductor material of the raw chip or due to beam distortion phenomena by virtue of electrostatic repulsion. That is known as the Boersch effect.

Limiting factors in terms of electron lithography are the availability of the very cost-intensive installations, the relatively long writing times, as well as restrictions due to the electron-sensitive lacquer layers employed.

For example the requirement often arises, starting from a given structure, to use that structure on a smaller scale. The given structure can have for example 1500 lines/mm which is to be altered for example to 2000 lines/mm, that is to say refined down. A further example is the staged production of membranes with nanotubes of defined diameter. In the case of holographic methods for example the resolution of the structures which can be achieved is limited by the light wavelength used. It is precisely in recent times that the interest in structures below that resolution, referred to as ‘sub wavelength structures’, is very high.

Often the use of very small structures fails on account of the availability of a suitable origination technology, costs and/or the time requirement.

In consideration of those factors the object of the present invention is to provide a method of the kind set forth in the opening part of this specification, which is relatively easily and inexpensively suitable for the targeted modification of microstructures or microstructured materials.

In accordance with the invention that object is attained by the features of claim 1, that is to say by the method steps:

a) production of a microstructure at and/or in the material of the object, and

b) volume contraction of the material for reducing the structure dimensions of the microstructure of the object.

The method according to the invention has the advantage that a suitable microstructure is produced in a first method step and that said microstructure is then reduced in its dimensions by volume contraction of the material. In that situation volume contraction is preferably effected while substantially maintaining the relative profiling of the microstructure.

In accordance with the invention the microstructure can be produced at and/or in the material of the object by means of all common methods, in particular by means of a lithography method or by means of a shaping method. The shaping method can be carried out by means of a die. Shaping by the die can be effected by mechanical and/or thermal deformation by pressing or by pouring on a medium.

Separation of the microstructured material from the die can be effected mechanically, by etching, by solvents, by burning, by pyrolysis and so forth, that is to say all possible methods can be employed.

The method according to the invention therefore includes the method steps:
direct writing or shaping of a microstructure in the material;
volume contraction of the material while substantially maintaining the relative structure profile with a corresponding reduction in the structure dimensions; and
use of the object obtained in that way for example as a component or as a die for shaping the correspondingly reduced microstructures.

Depending on the respective requirements involved, the last-mentioned method steps can be carried out once or a plurality of times in order to embody correspondingly fine microstructures.

As has already been stated, structuring of the respective material can be effected by means of lasers, by etching or by dissolving out regions by means of solvents, by the use of dies and so forth. Shaping by the dies is generally effected by mechanical and/or thermal deformation by pressing, by pouring on a medium with subsequent solidification, or by known lithographic processes. Solidification can be effected by drying, by chemical hardening, for example UV-hardening, and so forth.

The contact time between the die and the material depends on the respective system and the properties which are desired and which are to be achieved. That contact time can be <1 sec to several days. The dies can comprise various materials. Those materials can involve metals, plastic materials, inorganic materials and so forth. Separation of the dies from the material can be effected purely mechanically, by etching, by solvents, for example by dissolving off the die or for example the photoresist, or by burning or by pyrolysis. The separation time for the die from the material is dependent on the system used. By way of example hardening is effected by means of UV radiation during contact and subsequent separation and controlled pyrolysis.

Thermoplastic and/or thermosetting materials and/or elastomers can be used as the material in the method according to the invention. Likewise the materials used can be unfilled materials and/or materials filled with filler. Ceramic and/or metallic materials can also be used as the materials. Likewise it is possible for natural materials and/or materials produced from naturally occurring substances to be used as the materials. Therefore it is possible with the method according to the invention to use all materials which are distinguished by volume contraction—in part in combination with the respective processing procedure. Volume expansion is also possible. The invention is therefore also related thereto.

In the method according to the invention, it is also possible to employ combinations of the above-specified materials, for example composite materials.

The filler used is desirably filler particles whose particle size is smaller than the dimensions of the microstructure to be shaped. In that respect it has proven to be desirable if the ratio of microstructure dimensions: particle sizes is between 2:1 and ≧100:1, preferably of the order of magnitude >10:1.

‘Nanoparticles’ are commercially available, the particle size of which is between 3 and 30 nm. Such nanoparticles can be used for example in microstructures such as a sine structure with 1000 lines/mm.

Besides the particle size, the shape of the filler particles can also be of great influence; therefore it can be advantageous if, with the method according to the invention, filler particles of an elongate, fiber-form or flake-form configuration are used. Such filler particles of the last-mentioned kind can permit better shaping of the structures and thus if necessary can also be used with a disadvantageous ratio of microstructure dimensions: particle size. Filler particles which can be deformed in the shaping operation can also be advantageous. The filler particles can also be of a round configuration. The use of fillers can also lead to modifications in the microstructures. For example, structuring of the microstructure can be effected with ‘superposed’ nanostructures. In certain situations of use that can be advantageous and desirable.

With the method according to the invention volume contraction of the material for reducing the structure dimensions, preferably while substantially maintaining the relative profiling of the microstructure, can be effected by a physical and/or a chemical and/or a biological process. In that respect volume contraction can be effected by thermal shrinkage, by a drying process, with the discharge of water and/or solvent, by a setting process, by a sintering process, by a hardening process or by targeted carbonisation or coking of organic materials or ceramics. Likewise it is possible to use swelling processes which are known per se, in the case of volume expansion.

While the aim in relation to many technical materials is normally a degree of shrinkage which is as slight as possible, the method according to the invention often seeks to achieve a high degree of shrinkage, which can be achieved by certain modifications of the materials.

Examples of changes in volume are as follows:
polycarbonate injection molding volume change: about 2%
polyester—unfilled after hardening volume change: about 3-70%
argillaceous earths volume change: about 5-40%
carbonisation of ceramic materials volume change: about 5-50%
(in part organically modified)

The objects produced in accordance with the method of the invention can be employed as components or as dies for shaping microstructures. Uses of the materials are therefore for example:
optical elements or uses,
materials with surface-modified properties for the sanitary sector, for the iron and steel industry, for electronics, for electrical engineering, for the power station sector, for biological uses, in medicine, in diagnostics, in machine construction and so forth;
materials with volume-modified properties, for example with nanotubes in technical uses such as for example in filters, membranes, biological uses, in medicine, diagnostics, electronics and in optical elements;
use as dies for subsequent processes.

1-37. (canceled)

38. A method of surface modification and/or volume modification of a microstructure at and/or in the material of an object, wherein a microstructure is produced at and/or in the material of the object, wherein, to reduce the structure dimensions of the microstructure of the object, volume contraction of the material is effected while substantially maintaining the relative profiling of the microstructure by a physical and/or chemical process, and wherein natural materials and/or materials produced from naturally occurring substances are used as the materials, and that volume contraction is effected by a sintering process.

39. A method as set forth in claim 38, wherein the microstructure is produced at and/or in the material of the object by means of a lithography method.

40. A method as set forth in claim 38, wherein the microstructue is produced at and/or in the material of the object by means of a direct method or by means of a shaping method.

41. A method as set forth in claim 40, wherein the shaping method is carried out by means of a die.

42. A method as set forth in claim 41, wherein shaping by the die is effected by mechanical and/or thermal deformation by pressing.

43. A method as set forth in claim 41, wherein shaping by the die is effected by pouring on a medium.

44. A method as set forth in claim 41, wherein separation of the microstructured material from the die is effected mechanically, by etching, by solvents, by burning or by pyrolysis.

45. A method as set forth in claim 38, wherein ceramic and/or metallic materials are used as the materials.

46. A method as set forth in claim 38, wherein volume contraction is effected by thermal shrinkage.

47. A method as set forth in claim 38, wherein volume contraction is effected by carbonization.

48. A method as set forth in claim 38, wherein volume contraction is effected by coking.

49. A method as set forth in claim 38, wherein the object is used as a die for shaping microstructures.

50. A method as set forth in claim 49, wherein volume contraction of the microstructured die is repeatedly implemented.
